(19) United States
(12) Patent Application Publication
(10) Pub. No.: US 2003/0145708 A1
(43) Pub. Date: Aug. 7, 2003

(54) Method, apparatus and actuatable perforator for creating apertures in pipe and pipe produced thereby

(76) Inventor: David W. Presby, Sugar Hill, NH (US)

Correspondence Address: GEORGE W. DISHONG, ESQ., 40 BRYANT RD., JAFFREY, NH, 03452, US

(21) Appl. No.: 10/269,495

(22) Filed: Oct. 11, 2002

Related U.S. Application Data
(60) Provisional application No. 60/328,612, filed on Oct. 11, 2001.

(51) Int. Cl. B26F 1/24

(52) U.S. Cl. 83/660

(57) ABSTRACT

The invention is a method and apparatus for making conduit for use in leaching systems, and the conduit produced thereby. The conduit has apertures created during its formation. The apertures are not cut from the material of the conduit. The material that is perforated is “rolled”, and made a part of the inner surface of the conduit. Included is at least one perforator that is actuatable. The conduit-forming material being perforated (typically a plastic-type material) is semi-molten, as during formation of the conduit, or after formation of the conduit by heating the perforator, thereby causing the conduit-forming material to be rolled rather than cut in creating a perforation. The apparatus has at least one actuatable perforator or at least one multi-tipped sequentially actuatable perforator located in at least one of a plurality of conduit-forming molds. Each of the molds has first and second “mold-halves” which are advanced together in an open position, and then closed, creating a cavity wherein molten conduit-forming material is injected. After injection, the mold body formed by the closed mold halves continues to advance, and while the conduit-forming material is still semi-molten the at least one perforator is activated, thereby forming a perforation into the soft conduit before the material has completely hardened. The perforator tip portion(s) is then withdrawn, leaving a perforation of predetermined geometry and dimension, and having “inwardly rolled” edges. When the conduit is “set”, the mold-halves are opened, allowing the conduit, having apertures therein, to be removed and the now-open mold halves to return to the beginning of the cycle to be closed again and accept new molten conduit-forming material. Thus, there is a continuous cycle of conduit formation, using the same mold halves. The conduit produced is distinguishable from similar conduit because the perforations are not “cut out” but are created by rolling the material inwardly, thereby improving strength and enhancing functioning of the conduit.

### CROSS REFERENCE TO RELATED APPLICATIONS/CLAIM FOR PRIORITY

This application claims priority, under 35 USC § 119(e), to U.S. Provisional Application Serial No. 60/328,612 titled: Method, Apparatus and Actuatable Perforator for Creating Apertures in Plastic Pipe and Pipe Produced Thereby, filed on Oct. 12, 2002.

### FIELD OF THE INVENTION

This invention relates to systems for leaching liquid waste, particularly waste water. More particularly this invention relates to a specially designed cylindrical conduit or pipe for use in leaching systems.

Even more particularly the invention relates to cylindrical conduit which has apertures created during the manufacture/forming/extrusion of the conduit, however the apertures of the present invention can be formed after formation of the conduit as well.

Most particularly the invention is an apparatus, an actuatable perforator and methods for perforating corrugated conduit or smooth walled conduit (typically plastic-type material) while the conduit is in the process of extrusion and which perforations are not cut from the material of the conduit but wherein the material is “rolled” or “transferred” to and made a part of the inner wall surface of the conduit, and also includes the conduit produced by this method.

Further and even more particularly the invention is an actuatable perforator which may be sequentially and timely actuated to cause the perforation of the wall of conduit or pipe wherein the material of the portion of the pipe being perforated is semi-molten as, for example during the forming of the conduit or caused to be made semi-molten after formation of the conduit such as, for example, by heating of the actuatable perforator thereby causing the material to be rolled rather than cut, creating thereby a perforation of predetermined and selected geometry and dimension and which adds strength to the conduit formed.

Most particularly, the invention is particularly useful in combination with: (A) the septic tank maze apparatus defined and described in Applicant's U.S. Pat. No. 5,429,752 Issued Jul. 4, 1995, (B) with the use of multiple layers of fabric of varying deniers defined and described in “A METHOD AND APPARATUS FOR USING MULTILAYER MATERIAL IN PROCESSING OF SEPTIC EFFLUENT AND WASTE WATER” U.S. Pat. No. 5,954,451; Issued Sep. 21, 1999 and with the pipe constructions defined and described in “PLASTIC SEWAGE PIPE”, U.S. Pat. No. 6,461,078, filed Mar. 13, 2000, and based on Provisional Application Serial No. 60/124,706, Filed Mar. 15, 1999. These Patents are incorporated herein by reference thereto.

### BACKGROUND OF THE INVENTION/DESCRIPTION OF THE PRIOR ART

Many drainage pipes are produced from plastic materials, either by extrusion or blow molding, with the pipe being cut into lengths or rolled on a large drum to be carried in the field. To obtain high rigidity and maximum utilization of material, such drainage pipes are commonly corrugated with the corrugations extending circumferentially around the pipe. Corrugated plastic pipe is widely used for many types of domestic, agricultural, and industrial drainage and waste disposal systems.

Preferably, drainage holes are positioned in the wall of the inner corrugation, or the so-called valley portion, so that, when the pipe is ultimately buried in the earth, the drainage holes are not packed as tightly (i.e. with dirt, etc.) as would be the case if they were positioned in the outer corrugation, i.e., on the peaks. Having the perforations on the inner corrugation facilitates drainage from the pipe, but, for obvious reasons, complicates the formation of the perforations because of the difficulty in accessing, from outside of the pipe the valley portions of the pipe in order to form the perforations.

Additionally, it would be advantageous to have corrugated pipe with grooves/valleys which are deeper and which grooves have sidewalls which are substantially perpendicular to the bottom surface of the groove and perpendicular to the outer or top surface of the pipe. Because of the manner in which such pipe is perforated at the bottom surface of the grooves it has not been possible to make such a desirable corrugated pipe as taught herein. Applicant's U.S. Pat. No. 5,606,786 Issued Mar. 04, 1997 for “Apparatus and Method for Producing Pipe and Pipe Produced Thereby” teaches a machine and method for producing such desirable pipe. The U.S. Pat. No. 5,606,786 is incorporated herein by reference thereto.

It should be further pointed out that suspended solids have plagued the septic system and waste water treatment industry more in the last ten (10) or more years than in previous years. The increase in the problem is due in part to the evolution and development of some of the modern day cleaners which now make cleaning easier in that they cause grease and oil to dissolve into the water. The major problem with these cleaners and the septic tank system is that the suspended solids in passing through the tank neither cool enough nor make contact at a slow enough pace to separate from the water.

Lint and fuzz have also been an ongoing problem for the septic tank system to control. This material stays suspended in the septic tank liquid and normally passes through, remaining suspended in the effluent which subsequently also causes problems in the leach system connected with the septic tank.

Septic tanks generally available today do not effectively provide for the removal, in a manner which does not effect the cost and the performance characteristics of the septic treatment system, of suspended solids that are typically found in septic tank liquid. It is important that the amount of suspended solids that leaves the treatment tank be minimal so as not to adversely affect the subsequent treatment of the waste water/effluent. A leach field, for example, is adversely effected because the suspended solids will clog the receiving layer and also adversely affect the absorption characteristics of the leach bed.

Currently there are designs and equipment that attempt the removal of suspended solids. All of those known to the inventor of the now patented precipitation apparatus defined in U.S. Pat. No. 5,429,752 have failed to address the problem in an efficient manner because all the efforts attempt to “filter” the liquid. Filtration creates an additional set of problems. The filters can quickly become plugged, thereby slowing down or completely blocking the flow-through of the liquid through the treatment tank. The filters are expensive and are costly to maintain. Applicant's patented precipitation apparatus greatly reduces the level of suspended solids exiting the treatment tank and entering the leach system.

However, it would also be advantageous to have a treatment system which would include a leach system which would, more efficiently and effectively, process the leachate or effluent from the septic tank or precipitation apparatus. The obvious consequences of such an improved fluid-conducting conduit structure for use within a drainage field would be longer life, less area needed to handle a specific amount of outflow of liquid, and a cleaner and safer treated liquid returning to the environment.

There is nothing currently available which satisfies these needs and objectives. However, the invention; the apparatus, the method and the pipe herein defined and disclosed when in combination with the Patents incorporated herein by reference, does meet all of these objectives. As additional examples of the state of the art that do not address the needs and problems identified above, the following patents that relate to the general technology of the present invention are summarized below. None is as effective and as efficient as the instant apparatus and method.

U.S. Pat. No. 4,055,098 patent to Leloux for Manufacturing Corrugated Perforated Plastic Tubes discloses a device for manufacturing corrugated plastic pipe by subjecting an internally unsupported corrugated plastic tube, at a temperature between 30-70 deg. C., to the simultaneous action of at least two punching members in one or in two corrugations. The device uses at least two punching members, two of which are parallel and spaced a short distance from each other. The cutters are held in their non-operative positions by a spring, and are oblong steel strips which are resiliently secured at at least one end. The at least two cutters are active on either side of a symmetry plane which is substantially perpendicular to the longitudinal axis of the plastic tube. In order to obtain the desired number of perforations, optimally three pairs of cutters are disposed on the circumference of a sleeve that rotates. The device can also cut helically corrugated pipe. The device also has three ‘areas’ of each cutter that cut the pipe. The innermost points act first, then the sides act, and finally the outermost parts (which may be beveled) act. The temperature may vary but is below the softening temperature range of the plastic. It is a single puncturing device and is not multi-tipped.

The 4,421,810 patent to Rasmussen for Perforated Drainpipe and Method of Making Same discloses a perforated drainpipe made from at least one sheet of polymeric material that is formed in a tubular shape with adjacent edges spaced slightly apart, thereby creating a gap extending lengthwise along the now tubular sheet. To create ‘perforations’, at least one ribbon of polymeric material is helically wound around the tubular sheet, thus leaving perforations where parts of the gap are left uncovered by the helically wound ribbon(s) of polymeric material. The invention of this patent does not use any puncturing as the method for creating the perforations.

The 6,076,992 patent to Fukui et al., for Underdrain Pipe discloses a perforated pipe with alternating segments of pipe having circular and square cross sections. Small water collecting holes may be formed in either the sectionally circular sections only, the sectionally square sections only, or both, or even only on the top or bottom of the pipe. The water collecting holes may be formed sequentially in a place where the pipe is moved to the outside of the mold, or after the pipe which has been molded is solidified. This patent is cited as an example of perforated pipe.

The 4,163,619 patent to Fales for Corrugated Drainage Tubing with Helically Arranged Drainage Openings discloses a thermoplastic corrugated drainage tube with peaks and valleys and a plurality of drainage openings “internally cut” about the circumference of each valley. The openings in successive valleys are helically arranged. The openings are helically arranged to avoid significant weakening of the tube. The perforating device includes two belts through which the corrugated pipe is run, and a shaft that supports a cutting tool. The tool may be run and rotated by a motor, but is rotatable by frictional engagement with the tube. The tool has a plurality, in one embodiment six, of cutters equidistantly spaced and projecting radially outward to engage the bottoms of the valleys. The tube is cut from the inside, not the outside of the pipe.

U.S. Pat. No. 5,606,786 to Presby for producing pipe describes and discloses a method and apparatus for making corrugated plastic pipe with apertures in the valley portions of the corrugations. The device comprises a rotary cutter disposed within the pipe which cutter cuts the apertures from within the pipe.

U.S. Pat. No. 4,587,874 to Lupke, et. al. discloses a rotary punch. The rotary punch is a spindle carrying a cutting tool and a drive for rotating the spindle about its own axis while revolving the spindle about the pipe. The cutter periodically engages and perforates the pipe.

U.S. Pat. No. 4,204,447 to Slaughterbeck discloses an apparatus for perforating corrugated plastic pipe. The Slaughterbeck apparatus employs a plurality of reciprocally moving heated punches which punch radially into the pipe and are then removed to form perforations. The pipe is then translated to another position for the next punching step.

U.S. Pat. No. 4,180,357 to Lupke, et. al. discloses an apparatus and method for perforating pipe and method of producing part of such apparatus. The Lupke apparatus advances corrugated pipe along its axial path by rotatably driven lead screw members, the screw threading of which is in meshing engagement with the corrugations of the pipe. The lead screw members present outwardly directed cutters which are synchronized to simultaneously intersect the pipe thereby creating perforations.

U.S. Pat. No. 4,104,942 to Leloux discloses a device for manufacturing perforated plastic pipes. Disclosed is a device having at least one punching member, to which a velocity is imparted in the direction of conveyance of the plastic pipes. During the punching operation, the punching members remain substantially perpendicular with respect to the plastic pipes.

U.S. Pat. No. 3,916,763 to Maroschak discloses an apparatus for forming slits in tubes. The Maroschak apparatus an improved means of feeding a tube through a slitting station in a stepwise manner, wherein rotary cutting blades and moved into and out of cutting engagement with the tube between successive stepwise movements thereof.

U.S. Pat. No. 3,901,113 to Oltmanns, et. al. discloses a device to cut holes within the wave troughs of a corrugated tube, especially for drainage. The device employs tool supports geared with the waves of the tube. The tube and tool support are synchronized.

U.S. Pat. No. 3,877,831 to Maroschak discloses a method and apparatus for drilling holes in tubes. The tube is fed through a drilling station where one or more longitudinal rows are drilled in the wall of the tube by means of a corresponding number of rotating drill bits. The drilling station includes a separate drilling head for forming each row of holes. Each of the drilling heads is rotated in timed relation to the movement of the tube so as to drill holes therein without interrupting or retarding the movement of the tube.

U.S. Pat. No. 3,831,470 to Maroschak discloses a method and apparatus for forming slits in tubes. Maroschak discloses intermittently feeding the tube through a slitting station in a stepwise manner and moving a plurality of rotating cutting blades which encircle the path of travel of the tube into cutting engagement with the tube between successive stepwise movements. The apparatus includes a pair of rotary feed members which engage portions of the tube closely adjacent sets of rotary cutting blades arranged around the path of travel of the tube, and means for imparting stepwise movement to the tube in timed relation to the inward and outward movements of the cutting blades.

U.S. Pat. No. 3,824,886 to Hegler discloses an apparatus for cutting apertures in tubes. The Hegler apparatus employs means for revolving a cutter about the pipe to be cut in cooperation with a means for moving the cutting surface in an epitrochoid path as it passes through the exterior surface.

U.S. Pat. No. 3,698,222 to Blake discloses a perforating machine. The Blake machine employs a rotating punch and die roll means in cooperation with corrugated roll means. The punch roll being formed of disks separated by spacers.

The patents noted herein provide considerable information regarding past and current state of the art, and the developments that have taken place in this field of technology. The present invention provides many advantages over the inventions noted above. Again it is noted that none of the inventions listed above creates apertures during the extrusion or conduit/pipe-forming process and none does so by causing the “rolling” of the soft conduit-forming material into and onto the interior facing wall of the conduit/pipe being formed.

### SUMMARY OF THE INVENTION

The improved fluid-conducting conduit structure having the apertures/perforations as defined and claimed herein provides the advantages of more efficiently and effectively processing the leachate or effluent from the septic tank or precipitation apparatus; providing longer life for a septic system; allowing less area to be used to handle a specific amount of outflow of liquid; and provides a cleaner and safer treated liquid returned to the environment. In addition the invention provides these advantages without a large increase in cost; without requiring any additional maintenance and, in fact, requires less maintenance; is incorporatable into standard treatment designs and configurations; is easily installed as new or replacements into existing and in-place leach fields; and provides flexibility to incorporate a variety of specially designed uses to result in a custom system based upon special or specific needs within the treatment system.

This invention relates to systems for leaching liquid waste, particularly waste water. Specifically this invention relates to a specially designed cylindrical conduit or pipe for use in leaching systems. More specifically the invention relates to preferably cylindrical conduit which has rolled edge apertures, created preferably during the manufacture/forming/extrusion of the conduit but which may be created after a conduit is formed as well. Embodiments of the invention include an apparatus and method for perforating corrugated or smooth walled conduit/pipe while the conduit is in the process of extrusion (or after) and which perforations are not cut from the material of the conduit/pipe but wherein the material is “rolled” or “transferred” to and made a part of the inner wall surface of the conduit/pipe, and also includes the conduit/pipe produced by the methods.

Additional embodiments of the invention include at least one actuatable perforator which may be sequentially and timely actuated to cause the perforation of the wall of the conduit-forming material wherein the material of the portion being perforated is semi-molten as, for example during the forming of the conduit/pipe or caused to be made semi-molten after formation of the conduit/pipe such as, for example, by heating of at least a portion of the actuatable perforator thereby causing the conduit-forming material to be rolled rather than cut creating thereby a perforation of predetermined and selected geometry and dimension and which adds strength to the conduit at each perforation.

Generally, the apparatus has at least one actuatable perforator, wherein the perforator is preferably a sequentially actuatable perforator which may be multi-tipped and which is located within at least one of a plurality of conduit-forming molds. There is preferably, a plurality of “mold-halves”, a first mold-half and a second mold-half, which are continually advanced as first as mold-halves by, for example, a chain or similar type drive mechanism and which mold-halves are then closed creating a cavity wherein molten conduit-forming material is injected. As the mold-halves advance and while the conduit-forming material is still in a semi-molten state the at least one perforator is actuated and then withdrawn and forms thereby a perforation into the soft conduit-forming material. The perforator tip portion or portions is/are timely withdrawn to leave a perforation of selected geometry and having strengthening “inwardly rolled” edges protruding into the inside of the cavity of the conduit. The now-formed conduit is allowed to cool and set, as it is moved along by the drive mechanism, and at the time the newly-formed conduit is “set” the mold-halves are caused to open allowing the formed conduit/pipe, having apertures therein, to be removed from the molding machine and the mold halves returned to the beginning of the cycle for closing and injecting of new material for more conduit to be formed.

The perforated conduit/pipe made using this apparatus and method is distinguishable from similar conventional conduit/pipe because the perforations are not “cut out of the material” but are created by rolling the material inwardly, thus improving the strength and enhancing the functioning of the conduit/pipe when used as septic waste conduit/pipe.

With respect to the perforators, the instant invention provides the use of perforators with which can be made changes in the number of apertures, the size of aperture, configuration of aperture, angle of aperture, location of aperture, and which can provide randomly positioned apertures. Perforators may be activated or deactivated at will, giving full control of the perforators to the manufacture and design of the conduit/pipe. Further, the number of perforators per mold can change and some molds may have none, but at least one perforator will be positioned in one mold on the “chain” or group of molds in a corrugator machine. The shape of each tip part of a perforator can be different, such as for example with a three-tipped perforator wherein the first is a round point, second a square, third a triangularly-shaped point. Thus, for example, the perforation which results will be a triangle if the perforator is fully actuated, a square when halfway actuated and a round hole when only the first part of the multi-tipped perforator is actuated.

Thus, one aspect of the invention is to provide an apparatus that is easily and economically maintainable and which is effective to process liquid outflowing from a septic tank or treatment tank and cause the outflow liquid or effluent to be more efficiently and more effectively processed, and the processed liquid returned to the ground water system.

A further aspect of the invention is to provide an apparatus which is easily and economically adaptable to meet specific design criteria which are based upon types and quantity of suspended solids found or expected in a treatment system and which, when in use, will increase the life expectancy of a leaching system and reduce the normal area of a leach system.

A further aspect of the invention is to provide the improved fluid conducting conduit structure for use within a drainage field using corrugated conduit having an outer surface of a plurality of peaks and valleys and having a plurality of the perforations created as taught and claimed herein and located circumferentially within each valley region. The corrugated conduit is preferably comprised of plastic material and wherein each of the peaks has a plurality of dents substantially equally spaced around each peak, resulting in a reduction of outer surface area of the conduit contacting the first layer of fabric.

A particular aspect of the present invention is to provide a method for producing the conduit/pipe having apertures of selected geometries, the apertures being created by use of at least one actuatable perforator, which perforator may have multi-tipped sequentially actuated parts thereof wherein the perforators are timely actuated during the molding of the conduit and the apertures created without the removal of any substantial portion of the material of the conduit/pipe, creating thereby perforations having discontinuities directed inwardly toward the centerline of the conduit/pipe.

A still further aspect of the present invention is to provide a perforated conduit/pipe made by the processes of the present invention. The perforated conduit/pipe made by the processes of the present invention is distinctive in several aspects. The perforated conduit/pipe may have a non-linear or spiral pattern of perforations, thus making the conduit/pipe stronger than similar pipes with linear patterns of perforations. Also, the conduit/pipe perforated by the processes of the present invention may have distinctive perforations. The perforations may be either round, slotted, triangular, oblong, oval, square, trapezoidal, or have any other geometry which may enhance the performance of the conduit for specific applications.

A yet still further aspect of the present invention is to provide an actuatable perforator which may be sequentially and timely actuated to cause the perforation of the wall of conduit/pipe, wherein the conduit-forming material of the portion being perforated is semi-molten as, for example, during the forming of the conduit/pipe, or caused to be made semi-molten after formation of the conduit/pipe such as, for example, by heating of at least a portion of the actuatable perforator thereby causing the conduit-forming material to be rolled rather than cut, creating thereby a perforation of predetermined and selected geometry and dimension.

These and further aspects and advantages of the present invention will become apparent to those skilled in the art to which this invention pertains after a study of the present disclosure of the invention including the accompanying drawings and appended claims.

### BRIEF DESCRIPTION OF THE DRAWINGS

FIG. 1 is a schematic illustration of a 1st perforator part of an example three-tipped actuatable perforator of the invention;

FIG. 2. is a schematic illustration of a 2nd perforator part of a three-tipped actuatable perforator of the invention;

FIG. 3. is a schematic illustration of a 3rd perforator part of a three-tipped actuatable perforator of the invention;

FIG. 4 is a schematic illustration showing the example three-tipped sequentially actuatable perforator as an assembly of the 1st, 2nd and 3rd perforator parts;

FIG. 5 is a schematic illustration of the invention showing the first and the second mold halves assembled to make the mold used in molding the conduit/pipe, and having a plurality of perforators assembled thereto;

FIG. 6 is a schematic illustration of the invention showing the mold as disassembled into the first and the second mold halves and having a plurality of perforators assembled thereto;

FIG. 7 is an illustration of two particular aperture configurations which may be made by the perforators of the invention; and

FIGS. 8A and 8B are illustrations showing another embodiment of the sequentially actuatable perforator as an assembly of “doors” which sequentially, upon advance of a plunger portion of the perforator, cause the soft conduit-forming material, through which apertures are being created, to spread and roll inwardly of the direction of the advancing perforator tip portion.

### DESCRIPTION OF THE PREFERRED EMBODIMENTS

The following is a description illustrating examples of the preferred embodiments of the invention. Like reference numerals refer to like elements throughout.

The invention relates to systems for leaching liquid waste, particularly waste water. The invention provides a specially designed cylindrical conduit or pipe for use in leaching systems. The conduit of the invention has apertures created during the manufacture/forming/extrusion of the conduit or after its formation, and includes an apparatus and method for perforating corrugated or smooth walled conduit/pipe while the conduit is in the process of extrusion or after. The invention produces perforations that are not cut from the material of the conduit/pipe but wherein the material is “rolled” or “transferred” to, and made a part of, the inner wall surface of the conduit/pipe. The invention also includes the conduit/pipe produced by the methods of the invention.

A key to the invention is an actuatable perforator which may be sequentially and timely actuated to cause the perforation of the wall of conduit/pipe wherein the material of the portion of conduit/pipe being perforated is semi-molten as, for example during the forming of the conduit/pipe or caused to be made semi-molten after formation of the conduit/pipe such as, for example, by heating of the actuatable perforator thereby causing the material, such as plastic, to be rolled rather than cut creating thereby a perforation of predetermined and selected geometry and dimension without removing any of the material of the conduit/pipe.

The method of the invention includes at least one perforator that is actuatable. The conduit-forming material being perforated (typically a plastic-type material) is semi-molten, as during formation of the conduit, or after formation of the conduit by heating at least a portion of the perforator, thereby causing the conduit-forming material to be rolled rather than cut in creating a perforation. The apparatus has at least one actuatable perforator or at least one multi-tipped sequentially actuatable perforator located in at least one of a plurality of conduit-forming molds. Each of the molds has first and second “mold-halves” which are advanced together in an open position, and then closed, creating a cavity wherein molten conduit-forming material is injected. After injection, the mold body formed by the closed mold halves continues to advance, and while the conduit-forming material is still semi-molten the at least one perforator is actuated, thereby forming a perforation into the soft conduit before the material has completely hardened. The perforator is then withdrawn, leaving a perforation of predetermined geometry and dimension, and having “inwardly rolled” edges, as the conduit continues to advance along a drive mechanism. When the conduit is “set”, the mold-halves are opened, allowing the conduit, having apertures therein, to be removed and the now-open mold halves to return to the beginning of the cycle to be closed again and accept new molten conduit-forming material. Thus, there is a continuous cycle of conduit formation, using the same mold halves. The conduit produced is distinguishable from similar conduit because the perforations are not “cut out” but are created by rolling the material inwardly, thereby improving strength and enhancing functioning of the conduit.

Reference is now made to FIGS. 1-8B all of which illustrate by sketch examples of particular embodiments and features of the present invention.

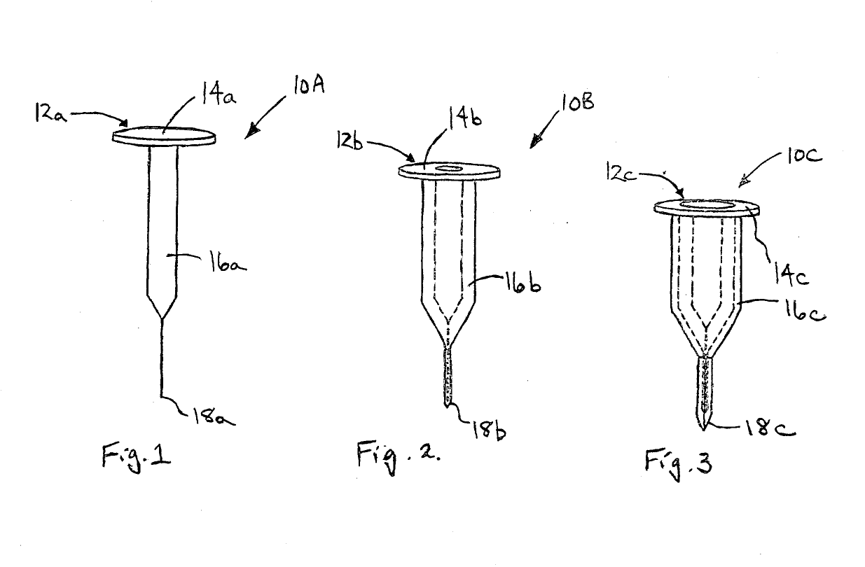

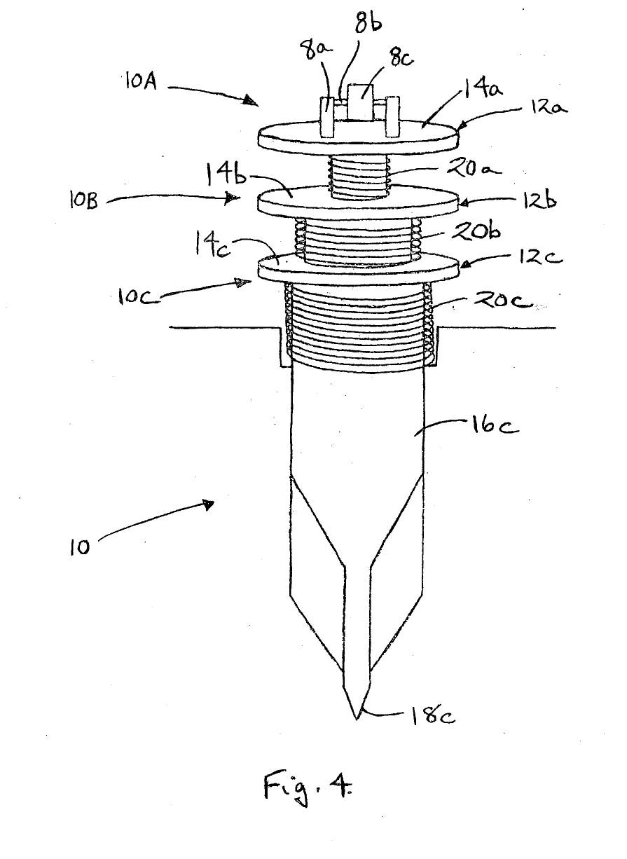

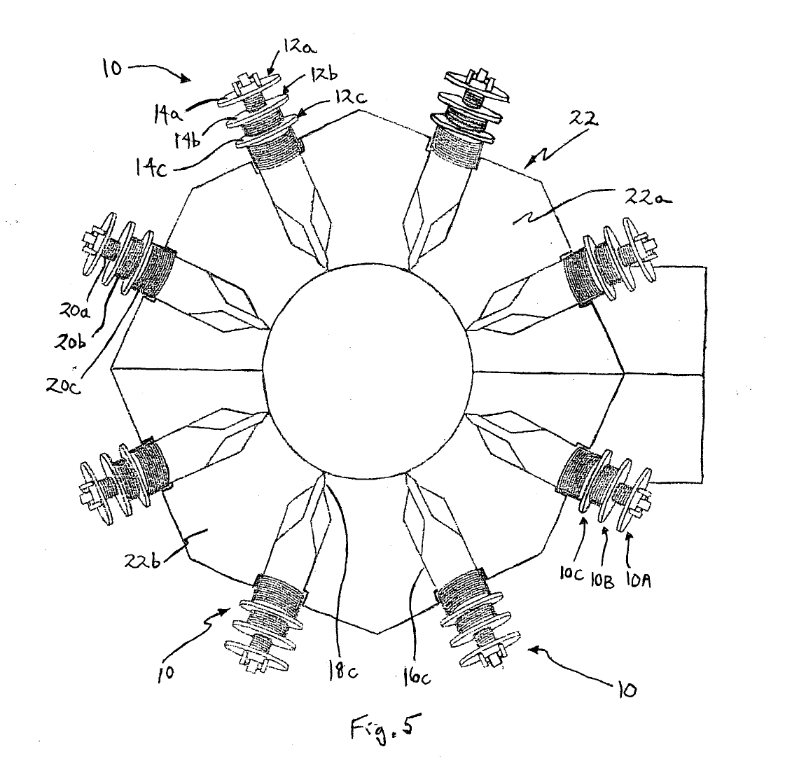

FIGS. 1-4 collectively schematically illustrate an embodiment of a sequentially actuatable perforator 10. FIGS. 1-3 specifically illustrate a multi-tipped perforator 10 having three tips. Multi-tipped perforator 10 is comprised of 1st actuatable perforator part 10A as shown in FIG. 1, 2nd actuatable perforator part 10B as shown in FIG. 2 and, in this particular example, 3rd actuatable perforator part 10C of the multi-tipped sequentially actuatable perforator 10 as shown in FIG. 3. Example perforator 10 is an assembly of the 1st, 2nd and 3rd perforator parts of the invention nested together, as shown in FIG. 4.

Each perforator part, 10A, 10B and 10C has a top portion 12a, 12b and 12c respectively, and an actuation surface 14a, 14b and 14c respectively, on to which pressure or force is applied to actuate the perforator 10. Each perforator part also has a shaft 16a, 16b and 16c respectively, each of which is progressively larger in diameter such that the shaft 16a of perforator part 10A (which may or may not be hollow) is slidable into and within shaft 16b (which would be hollow in this example) of perforator part 10B, and in turn shaft 16b of perforator part 10B is slidable into and within shaft 16c (which in this example would also be hollow) of perforator part 10C, such that a nested structure is formed as shown in FIG. 4. Each perforator part also ends in a tip portion 18a, 18b and 18c respectively which tip portions actually puncture and perforate conduit-forming material as the conduit is being formed, or which can perforate already-formed conduit. Whether or not shaft portion 16a, 16b, and/or 16 would be hollow would depend on the number of tips used, and the desired weight, strength and materials from which the shafts would be made, all of which would be chosen depending on the particular application for which each perforator 10 would be used.

Also shown in FIG. 4 is a plurality of actuating cushioning and return means, shown in this example as spring mechanisms and referred to herein as “springs” for ease of explanation. The cushioning and return means provide separation and cushioning, and return each perforator part to its starting position after actuation. During the actuation process the springs ensure that the top portions of each perforator part remain separated, even when all are fully actuated, and, dependent on the strength of the spring, provide a stopping point of actuation. Spring 20a is disposed along shaft 16a and controls actuation and withdrawal of perforator part 10a. Spring 20b is disposed along shaft 16b and controls actuation and withdrawal of perforator part 10B. Finally, spring 20C is disposed along shaft 16c and controls actuation and withdrawal of perforator part 10C.

Shown at the top of FIG. 4, on actuation surface 14a of perforator part 10a is an example actuation means 8 comprised of holding devices 8a, connecting shaft 8b and wheel device 8c. Actuation surfaces 14a, 14b and 14c and actuation means 8 protrude from the outer surface of mold body 22. One method of actuation could be, for example, at least one flat steel bar, rod or track type device that is disposed as part of the conduit-forming machine along the path of the drive mechanism and thus the path of the mold body 22 and conduit being formed. The track type device is formed such that it is angled to be located close enough, at at least one point along the path of the drive mechanism, to increasingly contact the protruding wheel device 8c which would then roll along the track type device and be pushed down gradually first on actuation surface 14a and eventually push on actuation surface 14c to gradually and steadily, yet sequentially, actuate all three perforator parts 10a, 10b and 10c respectively. The track type device would also be formed such that after it is at its closest distance to each mold body 22 as the mold bodies pass along the drive mechanism it angles and tapers away again from the mold body/drive mechanism such that pressure on the perforator parts is gradually released and they are gradually withdrawn thereby forming a perforation. Such a track type device could be formed at several locations around the drive mechanism, and thus around the mold bodies so as to have several track type devices activating a plurality of perforators. In addition, perforators could be actuated by a plurality of gear type devices located along the drive path along which the mold bodies pass, and having one or more protrusions or “cogs” located thereon and at a distance from the mold body as it passes such that when the perforator contacts the cog, it is actuated and then withdrawn is the perforator passes the gear type device. In yet another embodiment, the perforators could be activated by a pneumatic device. The above actuation devices of the conduit-forming machine examples are not shown but are readily understandable by one of ordinary skill in the art.

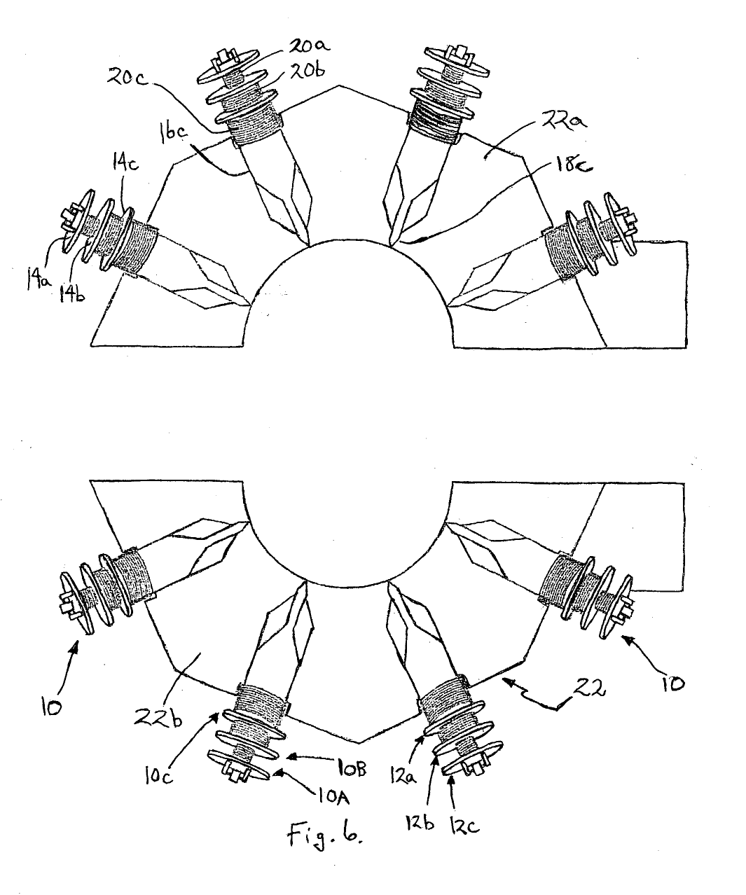

FIG. 5 is a schematic illustration of the invention showing a mold body 22 with first and the second mold halves 22a and 22b respectively. The mold halves 22a and 22b are shown assembled to make the whole mold, i.e. mold body 22, used in molding the conduit/pipe. Mold body 22 is shown having a plurality of multi-tipped perforators 10 assembled thereto.

FIG. 6 is a schematic illustration of the invention showing mold body 22 as disassembled into the first and the second mold halves 22a and 22b respectively and having a plurality of multi-tipped perforators 10 assembled thereto.

When used, the apparatus preferably has at least one actuatable perforator 10 fixedly located on at least either mold half 22a or 22b. The perforator shown in this example is preferably a multi-tipped sequentially actuatable perforator such as that shown as element 10. Perforators are located within at least one of a plurality of the conduit/pipe-forming molds/mold bodies 22. There is preferably a plurality of the mold-halves 22a and 22b which are advanced together as mold-halves by, for example, a continuously driving chain or similar type drive mechanism, and which mold-halves 22a and 22b are then closed to create mold body 22 which has a cavity wherein a molten material, preferably plastic or other suitable conduit-forming material, is injected. The closed mold-halves 22a and 22b continue to advance and while the conduit material is still in a semi-molten state at least one perforator 10 is timely actuated such that perforator 10 forms thereby a perforation into the soft plastic or other conduit-forming material. The perforator tip portion or portions 18a, 18b, and/or 18c is/are then timely withdrawn as the mold body 22 advances, leaving a perforation of selected geometry and having strengthening “inwardly rolled” edges protruding into the newly-formed conduit or pipe interior and formed from the conduit-forming material.

At the time the material of the newly-formed conduit is “set” the mold-halves 22a and 22b are caused to open allowing the formed conduit/pipe, having apertures therein, to be removed from the molding machine and the open mold halves 22a and 22b returned to the starting position for closing and filling with new material for the next piece of conduit to be formed. The perforated pipe/conduit made using this apparatus and method is distinguishable from similar conduit/pipe because the perforations are not “cut out of the material” but are created by rolling the material inwardly thereby resisting tearing, improving the strength and enhancing the functioning of the conduit/pipe when used as septic waste pipe by effectively adding additional material around the inner edges of each perforation.

While a preferred embodiment of the invention is conduit formed by the methods and actuation/perforation devices of the present invention during its initial manufacture and which is already perforated as it is formed, the methods and devices described herein are also useful to perforate already-formed conduit. One such method would be to use substantially any of the perforators described and claimed herein and assembled on a jig or other support means to position one or a plurality of such perforators, and further provide a means for heating and consequently softening that portion of the already-formed conduit/pipe in which the apertures are to be formed. Such means for heating could readily be a means for heating the perforator itself, or heat could be applied directly to that portion of the conduit/pipe being perforated before the heated or cool perforator is actuated. Thus the same “rolled” edged apertures and the same resulting strengthened conduit is formed, whether the apertures were formed during or after production of the conduit.

Thus, the invention also includes methods for producing the pipe/conduit described above and having apertures of selected geometries, the apertures being created by use of at least one actuatable perforator, which perforator may have multi-tipped sequentially actuated parts thereof, and wherein the perforators are timely actuated during the molding of the pipe/conduit and the apertures created without the removal of any substantial portion of the material of the pipe. Thus, perforations having discontinuities directed inwardly toward the centerline of the pipe/conduit, which inwardly rolled edges/discontinuities provide strength and enhance functioning of the conduit are created thereby.

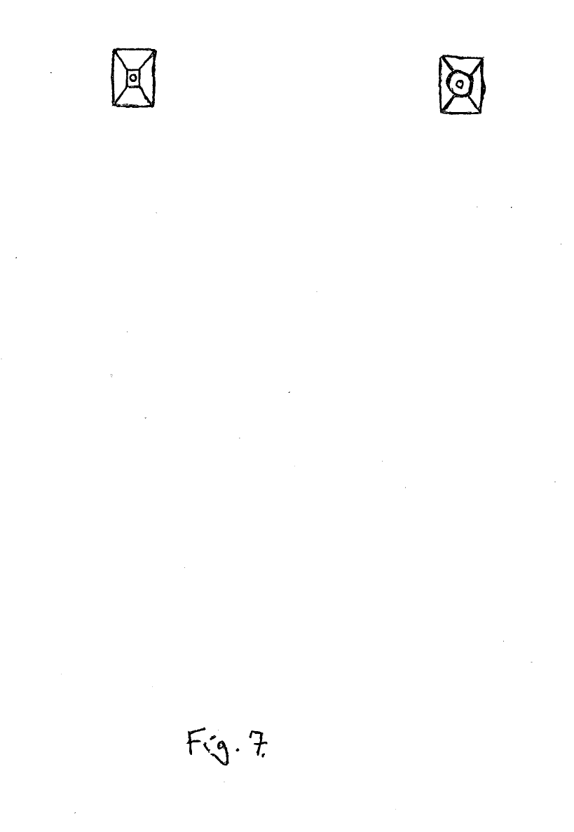

FIG. 7 is an illustration of two particular aperture configurations 24a and 24b which may be made by the perforators 10 of the invention. The instant invention allows for the use of perforators 10 on which can be made changes in the number of apertures, the size of apertures, configuration of apertures, angle of apertures, location of apertures, and positioning of apertures. Perforators may be activated or deactivated at will, giving full control of the perforators to the manufacture and design of the pipe/conduit.

In addition, the number of perforators per mold can change as desired. Some molds may have none, but at least one perforator will be positioned in one mold on the “chain” or series of molds in a corrugator or extruder machine. The shape of each part of a multi-tipped perforator can also be different, such as for example, first a round point, second a square, third a triangle. The perforation which results will be a triangle when the entire perforator is fully activated, or a square when halfway activated, and will be a round hole when just the first perforator part is activated. Such a three-part perforator for example is shown separated in FIG. 1 as discussed above.

Thus, the perforated conduit/pipe made by the processes and devices of the present invention is distinctive in several aspects. The perforated pipe/conduit may have a non-linear or spiral pattern of perforations, thus making the conduit/pipe stronger than similar pipes with only linear patterns of perforations. Also, the conduit/pipe perforated by the processes of the present invention may have distinctive perforations. The perforations may be either round, slotted, triangular, oblong, oval, square, trapezoidal, or have any other geometry which may enhance the performance of the conduit for specific applications. The perforations may be located at any location and angle on smooth-walled conduit. The perforations may also be located at any angle or location on corrugated conduit, including in valleys, on peaks, and even in and along the sidewalls forming the peaks and valleys of the corrugation if desired.

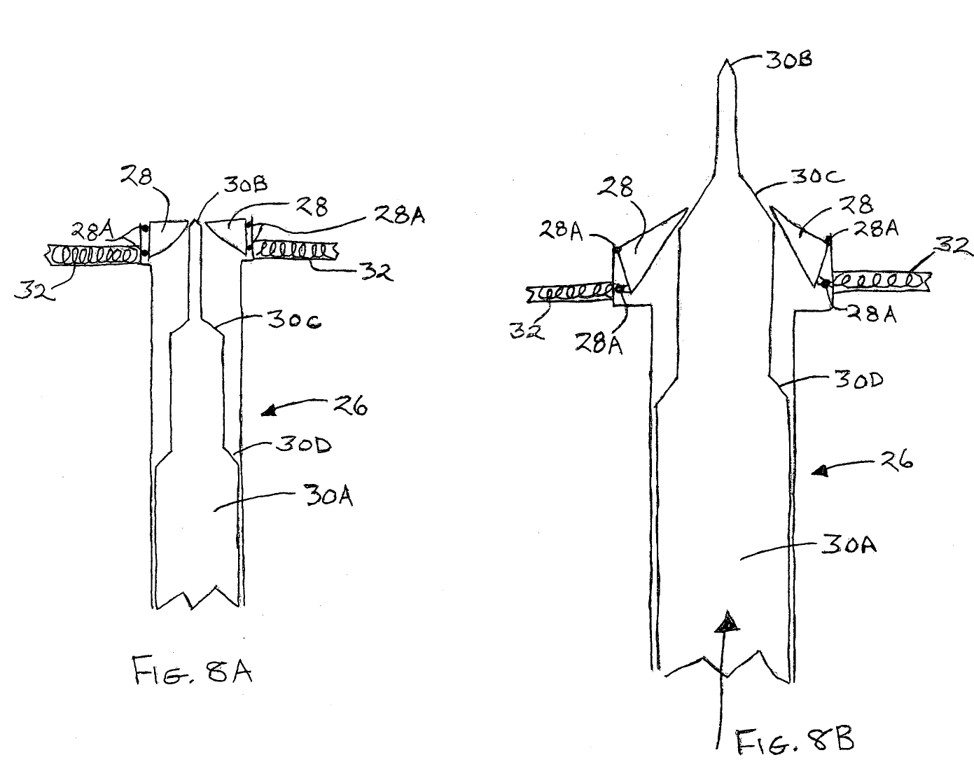

FIGS. 8A and 8B are illustrations showing another embodiment of a sequentially actuatable perforator 26 having a hollow sheath portion 28 with a proximal end and a distal end. The distal end has a widened portion having two hinged door portions 30 and two spring means 32, wherein said spring means 32 maintain each said door portion 30 in a closed position when said sequentially actuatable perforator 26 is not being actuated.

Perforator 26 also includes a plunger portion 34 within hollow sheath portion 28. Plunger portion 34 has a shaft 36 having a shaft proximal and a shaft distal end, and stepped or graduated diameter portions 36A and 36B. Shaft 36 is graduated from said shaft proximal end to said shaft distal end wherein the widest portion is at said shaft proximal end and is of a dimension slightly smaller than the interior dimension of hollow sheath 28, and wherein the shaft distal end terminates in a perforating tip 38.

Doors 30 sequentially, upon advance of the plunger 34 of perforator 26, cause the soft plastic or other material, through which apertures are being created, to spread and roll inwardly of the direction of the advancing perforator tip portion 38 and on to graduated wider portions 36A and 36B of plunger portion 34. With the continuing advance of plunger 34, doors 30 are caused to open further thereby sequentially making a larger aperture. Upon retraction of plunger 34, doors 30 close as a consequence of the force created by spring means 32. Thus, the size of the perforation can be adjusted/determined based on how far/to what extent the plunger is inserted into the plastic/conduit-forming material.

It is clear that there may be variations in the size and the shape of the conduit/pipe, in the materials used in the construction and in the orientation of the perforators, the molds, the manner of moving the molds, the manner of actuating the perforators and the geometries of the apertures. However, the main features of the invention are consistent and are:

1) The pipe/conduit is held in place by the mold-halves while the conduit/pipe is being perforated/punched (whether during or after initial formation of the conduit);

2) By creating the apertures during the conduit/pipe forming process, the conduit/pipe does not deform as a consequence of punching, piercing, cutting etc. and virtually none of the conduit/pipe material is lost or removed during the aperture creation process;

3) The need for guides or holders (for perforating pipe after its initial manufacture) may be eliminated because of the fixing in position of the perforators into the mold-halves; however, while the perforators are securely located in position on the mold halves, they are still removable/adjustable such that the numbers and locations of perforators can be changed to suit a particular application;

4) The progressive or sequentially actuatable perforator with at least two sections will stop hot plastic in the form stage from entering the aperture created by the perforator. If plastic were to follow up the aperture it would clog the aperture and deform the conduit/pipe;

5) No heating is necessary (with apertures formed during conduit manufacture) because the conduit-forming material is still warm resulting thereby in a faster process;

6) The use of multi-tipped sequentially actuatable perforators will help in the creation of a proper hole/aperture—the shape or geometry of the aperture/hole can be changed by using different and selected perforator parts; the first perforator part starts the hole and relieves the pressure needed to create the rest of the hole;

7) The number of perforations/holes per valley or per length can be easily changed by removal of perforators or simply by the control of which of the perforators are actuated and/or sequentially actuated for or during a particular conduit production;

8) Creating the aperture in the conduit/pipe at the time of molding process saves time by reducing substantially the number of steps in the processing of perforated conduit/pipe which basic steps were to A) Form the pipe, B) Reheat, C) Punch holes, D) Feed in and out of the punch machine, E) Alignment of the perforation i.e., alignment of the perforation/perforation machine with corrugation of the pipe;

9) The method and apparatus of the invention allows further for rapid and easy change of the pattern of apertures, change of the number of apertures needed or desired, and if advantageous, the perforation geometries may be varied and combined, for example, in one valley or in sequential valleys of the conduit/pipe;

10) The reaction time of the perforators is fast;

11) The manor of creation of the aperture leaves strengthening “inwardly rolled” edges protruding into the conduit/pipe cavity which allows more storage of sludge inside the conduit and provides additional strength to the conduit/pipe relative to apertures created by removal of material;

12) The perforators and the manor of mounting onto the mold and mold-halves permits the creation of apertures in valleys as well as on the tops of corrugations, i.e., on the peaks, and in addition, permits creation of apertures in the side walls between peaks and valleys. Further, by use of the invention, perforations can be created in tight valleys without cutting sidewalls or losing any substantial amount of strength of the conduit/pipe. The perforations created by, and which are part of the present invention, do not weaken the conduit/pipe because perforation is done when conduit/pipe is being formed. With prior methods, cutting of apertures can tear or crack pipe at the point of cutting after the pipe is cooled and formed, as compared with perforating according to the present invention - creating the apertures in the forming mold while the material of the conduit/pipe still hot. Flaring, i.e., the forming of the inwardly rolled edges at the perforation will also strengthen the conduit/pipe at the location of the aperture due, at least in part, to extra plastic/conduit-forming material build up, and after full curing the extra material will add strength and also resist tearing;

13) The perforators and the manor of mounting them onto the mold and mold-halves permits the positioning of perforators at an angle to the conduit/pipe and at any location on the conduit/pipe on smooth-wall or corrugated pipe;

14) Actuation of the perforators can be achieved with the use of “slide bars” or “wheels” or any other method that depresses the parts of the perforator at a set time and at proper levels/proper extent to insure a full actuation or a partial actuation for either a full size hole or a small hole, or a particularly shaped hole, which actuation takes place while the plastic pipe is being formed within the molds;

15) Alternatively levers and/or pneumatic methods may be used to deploy perforators/punches in different locations on the mold section;

16) Perforators may be angled so that they will go into the side walls of the corrugations;

17) Perforators may be heated to perforate conduit/pipe post-manufacture of the conduit/pipe; and

18) The methods and systems of the present invention may additionally be used with drainage pipe and clearly may be used with or without fabric covering, as disclosed above in Applicant's other inventions, whether the fabric covering is single or multi-layered.

It is clear that in the description provided below relative to the aspects of the technology of septic effluent processing and more particularly to the creation of perforations in plastic or similar material conduit/pipe which are described in FIGS. 1-7, everything described herein is applicable and advantageous for use with the corrugated pipe as disclosed in “PLASTIC SEWAGE PIPE”, U.S. Pat. No. 6,461,078, filed Mar. 13, 2000.

Further, it should be noted that the machines which make corrugated pipe are commonly called corrugaters. Those skilled in the art are well informed regarding the operation of such machines. Those skilled in the art are also well aware of the manner in which the “corrugaters” work and fully understand how the apparatus of the present invention can be/would be incorporated into the “corrugaters” to perform the functions as disclosed herein. Therefore, extensive explanation of how the devices of the present invention would be exactly physically used with “corrugators” is not included. In addition, the mold-halves 22 of the present invention would be custom designed in their particulars to meet the specifications of the specific pipe/conduit being made, and to include means for retaining and operating the perforators depending on the number, orientation, etc. of the perforators to be used. Such design and set up of molds and their use with corrugators would also be understood by one of skill in the art.

Additionally, as noted above, the present invention ideally works in conjunction with other inventions of the present inventor as disclosed for example in issued U.S. Pat. Nos. 5,954,451 and 6,461,078 which are incorporated herein by reference in their entirety. Thus, the present invention also provides an apparatus for use within a drainage field, which drainage field may be in combination with disposal and irrigation systems used in treatment of fluids and dispersal of fluids, and provides methods and devices for quickly and economically perforating any type of conduit for use in any application that benefits from perforated conduit.

It is thought that the present invention, the method, apparatus and actuatable perforators for perforating pipe either during the process of extrusion or after, and the pipe produced thereby is understood from the foregoing description and it will be apparent that various changes may be made in the form, construction and arrangement of the parts thereof without departing from the spirit and scope of the invention or sacrificing all of its material advantages, the forms hereinbefore described being merely preferred or exemplary embodiments thereof.

What is claimed is:

1. A sequentially actuatable perforating device comprising:
at least a first actuatable perforator part; and
a second actuatable perforator part into which said first perforator part fits;
wherein said first and said second actuatable perforator parts are sequentially actuatable, with said first actuatable perforator part actuated first, followed by said second actuatable perforatable part.

2. The device of claim 1 wherein said first actuatable perforator part comprises:
a top portion having a actuation surface;
a shaft connected at one end to said actuation surface; and
a perforating tip portion at an end of said shaft opposite to the end of said shaft connected to said top portion.

3. The device of claim 2 wherein said second actuatable perforator part comprises:
a top portion having a actuation surface;
a shaft connected at one end to said actuation surface; and
a perforating tip portion at an end of said shaft opposite to the end of said shaft connected to said top portion.

4. The device of claim 1 comprising:
a third actuatable perforator part.

5. The device of claim 4 wherein said third actuatable perforator part comprises:
a top portion having a actuation surface;
a shaft connected at one end to said actuation surface; and
a perforating tip portion at an end of said shaft opposite to the end of said shaft connected to said top portion.

6. The device of claim 3 wherein said shaft of said first actuatable perforator part is smaller in diameter than said shaft of said second actuatable perforator part such that said shaft of said first actuatable peforator part is slidable inside of said shaft of said second actuatable perforator part.

7. The device of claim 5 wherein said shaft of said second actuatable perforator part is smaller in diameter than said shaft of said third actuatable perforator part such that said shaft of said second actuatable peforator part is slidable inside of said shaft of said third actuatable perforator part.

8. The device of claim 3 further comprising:
a first spring means disposed around a portion of the outside surface of said shaft of said first actuatable perforator part, which said first spring means prevents said actuation surface of said first actuatable perforator part from resting directly on said actuation surface of said second actuatable perforator part when said first actuatable perforator part is inserted into said shaft of said second actuatable perforator part and actuated.

9. The device of claim 7 further comprising:
a second spring means disposed around a portion of the outside surface of said shaft of said second actuatable perforator part, which said second spring means prevents said actuation surface of said second actuatable perforator part from resting directly on said actuation surface of said third actuatable perforator part when said second actuatable perforator part is inserted into said shaft of said third actuatable perforator part.

10. The device of claim 5 further comprising:
a third spring means disposed around a portion of the outside surface of said shaft of said third actuatable perforator part, which said third spring means prevents said actuation surface of said third actuatable perforator part from resting directly on any surface of a conduit being perforated when said actuatable perforator is perforating said conduit.

11. The device of claim 1 comprising a heating means to heat said first actuatable perforator part.

12. The device of claim 1 comprising a heating means to heat already-formed conduit to soften said already-formed conduit before perforation by said actuatable perforating device.

13. The device of claim 2 wherein said perforating tip portion of said first actuatable perforator may be of any geometry including round, slotted, triangular, oblong, oval, square, trapezoidal, or rectangular.

14. The device of claim 3 wherein said perforating tip portion of said second actuatable perforator may be of any geometry including round, slotted, triangular, oblong, oval, square, trapezoidal, or rectangular.

15. The device of claim 4 wherein said perforating tip portion of said third actuatable perforator may be of any geometry including round, slotted, triangular, oblong, oval, square, trapezoidal, or rectangular.

16. The device of claim 1 wherein said first and said second actuatable perforator parts are selectively actuatable such that said first actuatable perforator part is actuatable alone or in combination with said second actuatable perforator part; and said second actuatable perforator part is actuatable in combination with said first actuatable perforator part.

17. The device of claim 5 wherein said first, said second and said third actuatable perforator parts are selectively actuatable such that said first actuatable perforator part is actuatable alone or in combination with said second actuatable perforator part, or in combination with said second and said third actuatable perforator parts; said second actuatable perforator part is actuatable in combination with either said first actuatable perforator part, or in combination with said first and said third actuatable perforator parts; and said third actuatable perforator part is actuatable sequentially in combination with said first and said second actuatable perforator parts; wherein said first actuatable perforator part is always actuatable first.

18. A device for forming perforated conduit, smooth-walled or corrugated, comprising:
at least one mold body comprising:
at least a first mold half and at least a second mold half;
wherein said first and said second mold halves are advanceable linearly together and wherein said first and said second mold-halves are closeable, thereby creating a cavity into which molten conduit-forming material is injectable; and wherein said at least one mold body is openable to release said material when said material is set and formed as conduit; and
at least one tapered sequentially actuatable perforator positioned in, and held in place by, said first or said second mold-half, wherein while said first and said second mold halves are closed and said material is in said mold body, at least one actuatable perforator is actuated, thereby forming a perforation into the soft, semi-molten material.

19. The device of claim 18 comprising a drive means for advancing said first and said second mold-halves.

20. The device of claim 19 wherein said drive means comprises a chain or cable means.

21. The device of claim 18 comprising an actuating means for actuating and withdrawing said at least one actuatable perforator.

22. The device of claim 21 wherein said actuating means is a track-type means, wheel means or a pneumatic means for actuating said at least one actuatable perforator.

23. The device of claim 18 wherein said at least one actuatable perforator is mountable in said first or said second mold-half at any desired angle to said conduit formed within said at least one mold body, and at any location along said conduit.

24. The device of claim 18 comprising:
at least one means for actuating each said at least one actuatable perforator at a predetermined and selected time and extent to insure either full or partial actuation for either a full size perforation or a small perforation of said conduit depending on said extent to which said at least one actuatable perforator is actuated.

25. The device of claim 18 wherein at least one of said at least one actuatable perforator is an actuatable perforator as claimed in claim 1.

26. A method for forming and perforating corrugated or smooth walled conduit, said method comprising:
forming at least one conduit-forming mold body, each said at least one mold body comprised of a first mold-half and a second mold-half;
removably locating at least one single or multi-tipped sequentially actuatable perforator within at least one of either said first or said second mold-halves of said at least one conduit-forming mold body;
continually linearly advancing said first and said second mold-halves together, throughout the method;
closing said first and said second mold-halves, thereby creating a cavity wherein conduit-forming material is injectable;
injecting molten conduit-forming material into said cavity;
while said conduit-forming material is still in a semi-molten state actuating said at least one actuatable perforator such that said actuatable perforator is actuated to form a perforation in the soft conduit-forming material;
withdrawing said at least one actuatable perforator such that a perforation having inwardly rolled edges is left in said soft conduit-forming material and no conduit forming material is removed;
allowing the newly formed perforated conduit to cool and set;
opening said first and said second mold-halves of each said at least one mold body; and
removing said formed conduit, having perforations therein, from said at least one conduit-forming mold body.

27. The method of claim 26 comprising:
locating said at least one single or multi-tipped sequentially actuatable perforator at any angle relative to said conduit formed inside each said mold body, and at any location along said mold body and thus said conduit formed therein.

28. The method of claim 26 comprising:
actuating each said at least one single or multi-tipped actuatable perforator at a predetermined and selected time and extent to insure either full or partial actuation for either a full-size perforation or a small perforation of said conduit depending on the extent to which said at least one actuatable perforator is actuated.

29. The method of claim 26 comprising:
locating any desired number of said single or multi-tipped sequentially actuatable perforators at any angle relative to said conduit formed inside each said mold body, and any location along said mold body and thus said conduit formed therein, and actuating any desired number of said at least one single or multi-tipped sequentially actuatable perforators at a selected time as desired to produce a desired number, size and location of apertures in said conduit.

30. Perforated conduit comprising:
smooth-walled or corrugated conduit formed by injecting molten conduit-forming material into a cavity formed in at least one mold body comprised of a first and a second mold-half which are closed together to form said cavity; then perforating said conduit-forming material while still in a semi-molten state inside said at least one mold body using at least one single or multi-tipped sequentially actuatable perforator, such that perforation of said conduit is accomplished concurrent with formation of said conduit.

31. The perforated conduit of claim 30 comprising:
at least one aperture having thickened inwardly rolled edges formed of the same material as said conduit, said inwardly rolled edges formed by said at least one single or multi-tipped sequentially actuatable perforator as said perforator pushes through and perforates the semi-molten conduit-forming material of said conduit while said conduit is still in said at least one mold body.

32. The perforated conduit of claim 31 wherein said at least one aperture is locatable at any point on smooth-walled conduit; and in valleys, on peaks, or in side walls between valleys and peaks of corrugated conduit.

33. Perforated conduit comprising:
already-formed smooth-walled or corrugated conduit;
at least one aperture formed in said already-formed conduit wherein said at least one aperture comprises thickened inwardly rolled edges formed of the same material as said already-formed conduit; and
wherein said perforation is formed by at least one single or multi-tipped actuatable perforator either by heating said already-formed conduit at each said location of a said aperture to be formed before said aperture is formed, or by heating at least a tip portion of said at least one actuatable perforator before perforation of said already-formed conduit.

34. An actuatable perforator comprising:
a hollow sheath portion having a proximal end and a distal end, said distal end comprising:
a widened portion having two hinged door portions and two spring means, wherein said spring means maintain each said door portion in a closed position when said sequentially actuatable perforator is not being actuated;
a plunger portion within said hollow sheath portion comprising:
a shaft having a shaft proximal and a shaft distal end, and a stepped or graduated diameter which is graduated from said shaft proximal end to said shaft distal end wherein the widest portion is at said shaft proximal end and is of a dimension slightly smaller than the dimension of said hollow sheath, and wherein said shaft distal end terminates in a perforating tip.

35. A method of forming and perforating corrugated or smooth walled conduit, said method comprising:
forming at least one conduit-forming mold body, each said at least one mold body comprised of a first mold-half and a second mold-half;
locating at least one actuatable perforator of claim 33 within at least one of either said first or said second mold-halves of said at least one conduit-forming mold body;
linearly advancing said first and said second mold-halves together continually throughout the process;
closing said first and said second mold-halves, thereby creating a cavity wherein conduit-forming material is injectable;
injecting molten conduit-forming material into said cavity;
while said conduit-forming material is still in a semi-molten state, actuating said at least one sequentially actuatable perforator such that said at least one sequentially actuatable perforator forms a perforation in the soft conduit-forming material;
withdrawing said at least one sequentially actuatable perforator such that a perforation having inwardly rolled edges is left in said soft conduit-forming material and no conduit-forming material is removed;
allowing the newly formed perforated conduit to cool and set;
opening said first and said second mold-halves of each said at least one mold body; and
removing said formed conduit, having perforations therein, from said at least one conduit-forming mold body.

36. A device for forming perforated conduit, smooth-walled or corrugated, comprising:
at least one mold body comprising:
at least a first mold half and at least a second mold half;
wherein said first and said second mold halves are advanceable linearly and wherein said first and said second mold-halves are closeable, thereby creating a cavity into which molten conduit-forming material is injected; and wherein said at least one mold body formed by closing said first and said second mold-halves is openable to release said conduit when said conduit-forming material is set and formed as conduit; and
at least one actuatable perforator of claim 33 positioned in, and held in place by, said first or said second mold-half, wherein said at least one actuatable perforator of claim 33 is actuatable while said first and said second mold halves are closed and said conduit-forming material is in said mold body, such that said at least one actuatable perforator forms a perforation into the soft, semi-molten conduit-forming material within said cavity formed by said first and said second mold-halves when closed.
